(19) United States
(12) Patent Application Publication
(10) Pub. No.: US 2019/0101109 A1
(43) Pub. Date: Apr. 4, 2019

(54) VALVE STOP

(71) Applicant: S.P.M. Flow Control, Inc., Fort Worth, TX (US)

(72) Inventors: Adalberto Cortes, Fort Worth, TX (US); Justin Cummings, Fort Worth, TX (US); Allen Sutton, Weatherford, TX (US)

(21) Appl. No.: 16/150,087

(22) Filed: Oct. 2, 2018

Related U.S. Application Data
(60) Provisional application No. 62/566,961, filed on Oct. 2, 2017.

(51) Int. Cl. F04B 19/00; F16K 1/52

(52) U.S. Cl. CPC F04B 19/00; F16K 1/523

(57) ABSTRACT

A valve stop is provided for a valve assembly of a pump. The valve stop includes a tripod having a hub and three legs extending radially outward from the hub to end portions of the legs. The tripod is configured to be operatively connected to a valve body of the valve assembly to limit travel of the valve body. The end portions of the legs are configured to engage a wall of a fluid passage of the pump. A locator extends outward from the tripod to a handle of the locator. The handle of the locator is configured to engage an internal portion of the pump.

### CROSS-REFERENCE TO RELATED APPLICATION

This Application claims priority to and the benefit of U.S. Provisional Patent Application Ser. No. 62/566,961, filed on Oct. 2, 2017, which is incorporated herein by reference in its entirety.

### TECHNICAL FIELD

This disclosure relates to reciprocating pumps, and, in particular, to valve assemblies used in reciprocating pumps.

### BACKGROUND OF THE DISCLOSURE

In oilfield operations, reciprocating pumps are used for different applications such as fracturing subterranean formations to drill for oil or natural gas, cementing the wellbore, or treating the wellbore and/or formation. A reciprocating pump designed for fracturing operations is sometimes referred to as a “frac pump.” A reciprocating pump typically includes a power end and a fluid end (sometimes referred to as a cylindrical section). The fluid end can be formed of a one piece construction or a series of blocks secured together by rods. The fluid end includes a fluid cylinder having a plunger passage for receiving a plunger or plunger throw, an inlet fluid passage, and an outlet fluid passage (sometimes referred to as a discharge passage).

During operation of a reciprocating pump, a fluid is pumped into the fluid cylinder through the inlet passage and out of the pump through the outlet passage. The inlet and outlet passages each include a valve assembly to control the flow of fluid into and out of the fluid cylinder. For example, the valve assemblies can be differential pressure valves that are opened by differential pressure of fluid and allow the fluid to flow in only one direction through the corresponding inlet or outlet passage. The valve assemblies typically include a spring that biases a valve body of the valve assembly to the closed position of the valve assembly. A valve stop is provided to limit the travel of the valve body in the open position of the valve assembly. More particularly, the valve stop prevents the valve body from moving past the fully open position of the valve assembly.

But, at least some known valve stops may be difficult to install and/or may impede the flow of fluid through the corresponding fluid passage. For example, valve stops traditionally take the form of a bar that extends across the diameter of the corresponding fluid passage. Installation of the valve stop requires an installer to position one end of the bar within the fluid passage and then force the other end of the bar into position across the diameter of the fluid passage. But, installing the valve stop in such a manner may be imprecise, may require one or more tools, and/or may be dangerous to the installer. Moreover, and for example, the bars of conventional valve stops may create turbulence that slows that flow of fluid through the corresponding fluid passage.

### SUMMARY

This summary is provided to introduce a selection of concepts in a simplified form that are further described below in the Detailed Description. This summary is not intended to identify key features or essential features of the claimed subject matter. Nor is it intended to be used as an aid in determining the scope of the claimed subject matter.

In a first aspect, a valve stop is provided for a valve assembly of a pump. The valve stop includes a tripod having a hub and three legs extending radially outward from the hub to end portions of the legs. The tripod is configured to be operatively connected to a valve body of the valve assembly to limit travel of the valve body. The end portions of the legs are configured to engage a wall of a fluid passage of the pump. A locator extends outward from the tripod to a handle of the locator. The handle of the locator is configured to engage an internal portion of the pump.

In one embodiment, the hub of the tripod comprises an opening extending therethrough.

In some embodiments, the hub of the tripod includes an annulus.

In some embodiments, the hub of the tripod includes at least one of a curved or tapered profile.

In one embodiment, the legs of the tripod include at least one of a curved or tapered profile.

In some embodiments, the locator includes a stem that extends outward from the tripod to a crossbar of the handle.

In one embodiment, the tripod is configured to engage a spring of the valve assembly to limit the travel of the valve body of the valve assembly.

In one embodiment, the handle of the locator is configured to engage a suction cover of the pump.

In a second aspect, a valve stop is provided for a valve assembly of a pump. The valve stop includes a stop body configured to be operatively connected to a valve body of the valve assembly to limit travel of the valve body. The stop body includes a hub and legs extending radially outward from the hub to end portions of the legs. The end portions of the legs are configured to engage a wall of a fluid passage of the pump. The legs include at least one of a curved or tapered profile.

In one embodiment, the legs include a teardrop profile.

In some embodiments, the legs include at least one of a circular, oval, triangular, trapezoidal, diamond, hexagonal, or octagonal profile.

In some embodiments, the stop body includes a locator extending outward from at least one of the hub or the legs. The locator is configured to engage an internal portion of the pump.

In some embodiments, the stop body includes a locator having a stem that extends outward from at least one of the hub or the legs to a crossbar that is configured to engage an internal portion of the pump.

In one embodiment, the hub includes an opening extending therethrough.

In one embodiment, the hub includes at least one of a curved or tapered profile.

In a third aspect, a pump includes a fluid passage and a valve assembly held within the fluid passage. The valve assembly includes a valve body configured to move between an open position and a closed position. The valve assembly includes a valve stop having a tripod that includes a hub and three legs extending radially outward from the hub to end portions of the legs. The tripod is operatively connected to the valve body such that the tripod is configured to limit travel of the valve body in the open position of the valve body. The end portions of the legs are configured to engage a wall of the fluid passage.

In one embodiment, the valve stop includes a locator extending outward from the tripod to a handle of the locator.

In some embodiments, the legs of the tripod include at least one of a curved or tapered profile.

In one embodiment, the pump includes a suction cover and the valve stop includes a locator having a stem that extends outward from tripod to a crossbar of the locator. The crossbar is engaged with the suction cover.

In some embodiments, the valve assembly includes a spring configured to bias the valve body to the closed position. The tripod is engaged with the spring to limit the travel of the valve body in the open position.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

The accompanying drawings facilitate an understanding of the various embodiments.

FIG. 1 is an elevational view of a reciprocating pump assembly according to an exemplary embodiment.

FIG. 2 is a cross-sectional view of a fluid end portion of the reciprocating pump assembly shown in FIG. 1 according an exemplary embodiment.

FIG. 3 is a cross-sectional view of a portion of the fluid end portion shown in FIG. 2 illustrating an inlet valve assembly according to an exemplary embodiment.

FIG. 4 is a perspective view of a valve stop of the inlet valve assembly shown in FIG. 3 according to an exemplary embodiment.

FIGS. 5-7 are elevational views of the valve stop shown in FIG. 4.

FIG. 8 is a plan view of the valve stop shown in FIGS. 4-7.

FIG. 9 is a cross-sectional view of a leg of the valve stop shown in FIGS. 4-8 taken along the line 9-9 of FIG. 8 according to an exemplary embodiment.

FIG. 10 illustrates examples of cross-sectional shapes of the leg shown in FIG. 9 according to other exemplary embodiments.

FIG. 11 is a cross-sectional view of the fluid end portion shown in FIGS. 1-3 illustrating the valve stop shown in FIGS. 4-10 installed therein according to an exemplary embodiment.

FIG. 12 is a cross-sectional view of a portion of the fluid end portion shown in FIG. 2 illustrating an exemplary test of the flow of fluid through the valve stop shown in FIGS.

FIG. 13 is a cut-away perspective view of the exemplary test shown in FIG. 12.

Corresponding reference characters indicate corresponding parts throughout the drawings.

### DETAILED DESCRIPTION

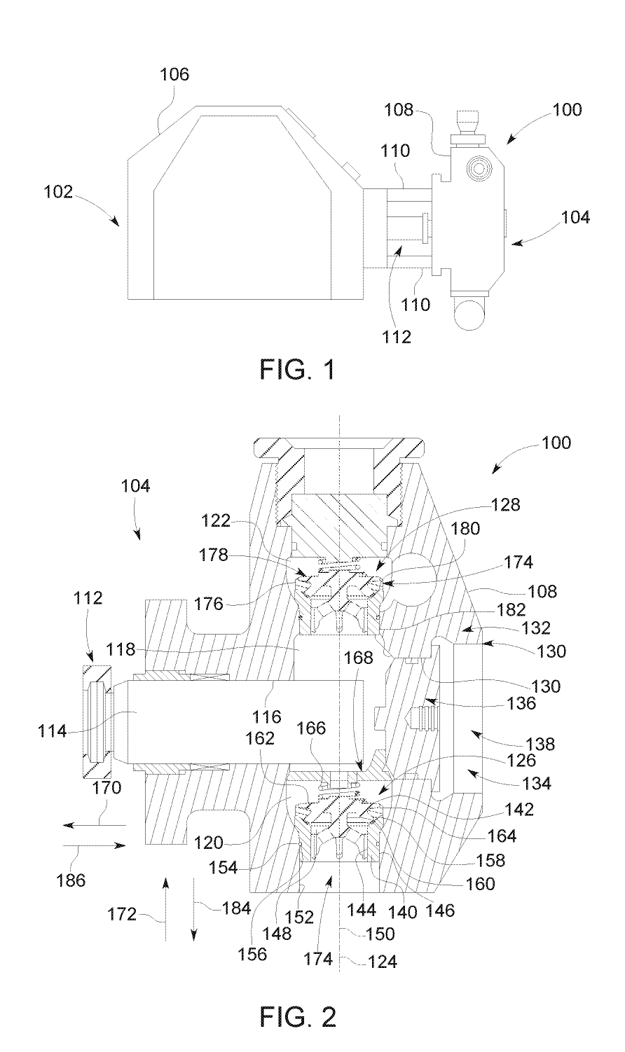

Referring to FIG. 1, an illustrative embodiment of a reciprocating pump assembly 100 is presented. The reciprocating pump assembly 100 includes a power end portion 102 and a fluid end portion 104 operably coupled thereto. The power end portion 102 includes a housing 106 in which a crankshaft (not shown) is disposed. Rotation of the crankshaft is driven by an engine or motor (not shown) of the power end portion 102. The fluid end portion 100 includes a fluid cylinder 108 (sometimes referred to as a “fluid end block”), which in the exemplary embodiment is connected to the housing 106 via a plurality of stay rods 110. Other structures may be used to connect the fluid end portion 100 to the housing 106 in addition or alternatively to the stay rods 110. In operation, the crankshaft reciprocates a plunger rod assembly 112 between the power end portion 102 and the fluid end portion 104 to thereby pump (i.e., move) fluid through the fluid cylinder 108.

According to some embodiments, the reciprocating pump assembly 100 is freestanding on the ground, mounted to a trailer for towing between operational sites, mounted to a skid, loaded on a manifold, otherwise transported, and/or the like. The reciprocating pump assembly 100 is not limited to frac pumps or the plunger rod pump shown herein. Rather, the embodiments disclosed herein may be used with any other type of pump that includes a valve assembly having a valve stop.

Referring now to FIG. 2, the plunger rod assembly 112 includes a plunger 114 extending through a plunger passage 116 and into a pressure chamber 118 formed in the fluid cylinder 108. At least the plunger passage 116, the pressure chamber 118, and the plunger 114 together may be characterized as a “plunger throw.” According to some embodiments, the reciprocating pump assembly 100 includes three plunger throws (i.e., a triplex pump assembly); however, in other embodiments, the reciprocating pump assembly 100 includes a greater or fewer number of plunger throws.

In the embodiment illustrated in FIG. 2, the fluid cylinder 108 includes inlet and outlet fluid passages 120 and 122, respectively, formed therein. The inlet and outlet fluid passages are coaxially disposed along a fluid passage axis 124 in the embodiment shown in FIG. 2. As described in greater detail below, fluid is adapted to flow through the inlet and outlet fluid passages 120 and 122, respectively, and along the fluid passage axis 124. An inlet valve assembly 126 is disposed in the inlet fluid passage 120 and an outlet valve assembly 128 is disposed in the outlet fluid passage 122. In FIG. 2, the valve assemblies 126 and 128 are spring-loaded, which, as described in greater detail below, are actuated by at least a predetermined differential pressure across each of the valve assemblies 126 and 128.

The fluid cylinder 108 of the fluid end portion 104 of the reciprocating pump assembly 100 includes an access port 130. The access port 130 is defined by an opening that extends through a body 132 of the fluid cylinder 108 to provide access to the pressure chamber 118 and thereby internal components of the fluid cylinder 108 (e.g., the inlet valve assembly 126, the outlet valve assembly 128, the plunger 114, etc.) for service (e.g., maintenance, replacement, etc.) thereof. The access port 130 of the fluid cylinder 108 is closed using a suction cover assembly 134 to seal the pressure chamber 118 of the fluid cylinder 108 at the access port 130. The suction cover assembly 134 includes a suction cover 136 and a suction cover nut 138 that holds the suction cover 134 within the access port 130.

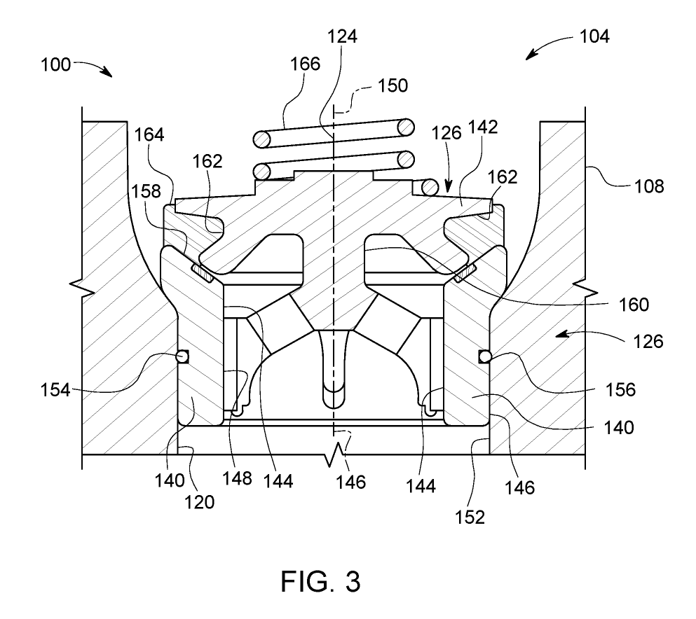

Referring now to FIGS. 2 and 3, the inlet valve assembly 126 includes a valve seat 140 and a valve body 142 engaged therewith. The valve seat 140 includes a body having an inner surface 144 and an outer surface 146. The inner surface 144 forms an inlet valve bore 148 that extends along a valve seat axis 150, which is coaxial with the fluid passage axis 124 when the inlet valve assembly 126 is disposed in the inlet fluid passage 120. The outer surface 146 of valve seat 140 engages in physical contact with a wall 152 of the inlet fluid passage 120. A sealing element 154 (e.g., an o-ring, etc.) may be disposed in a groove 156 formed in the outer surface 146 of valve seat 140 to sealingly engage the wall 152 of the inlet fluid passage 128. According to some examples, the outer surface 146 of the valve seat 140 forms an interference fit (i.e., press-fit) with the wall 152 of the inlet fluid passage 120 to hold the valve seat 140 within the inlet fluid passage 120. The valve seat 140 includes a shoulder 158, which in the exemplary embodiment is tapered (i.e., extends at an oblique angle relative to the valve seat axis 150). In other examples, the shoulder 158 of the valve seat 140 extends approximately perpendicular to the valve seat axis 150.

The valve body 142 includes a tail portion 160 and a head portion 162 that extends radially outward from the tail portion 160. The head portion 162 holds a seal 164 that sealingly engages at least a portion of the shoulder 158 of the valve seat 140. In the exemplary embodiment, the head portion 162 is engaged and otherwise biased by a spring 166, which, as discussed in greater detail below, biases the valve body 142 to a closed position that prevents fluid flow through the inlet valve assembly 126.

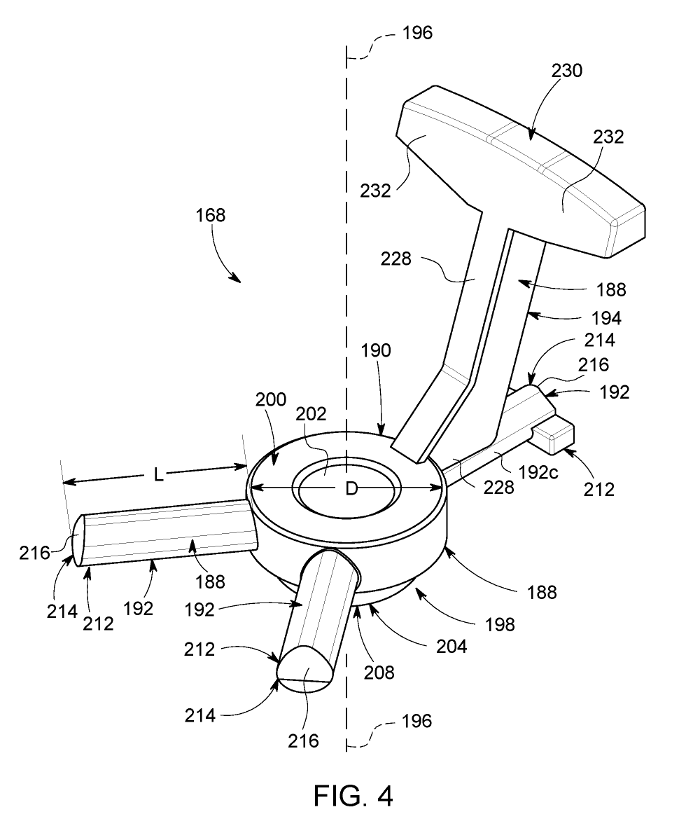

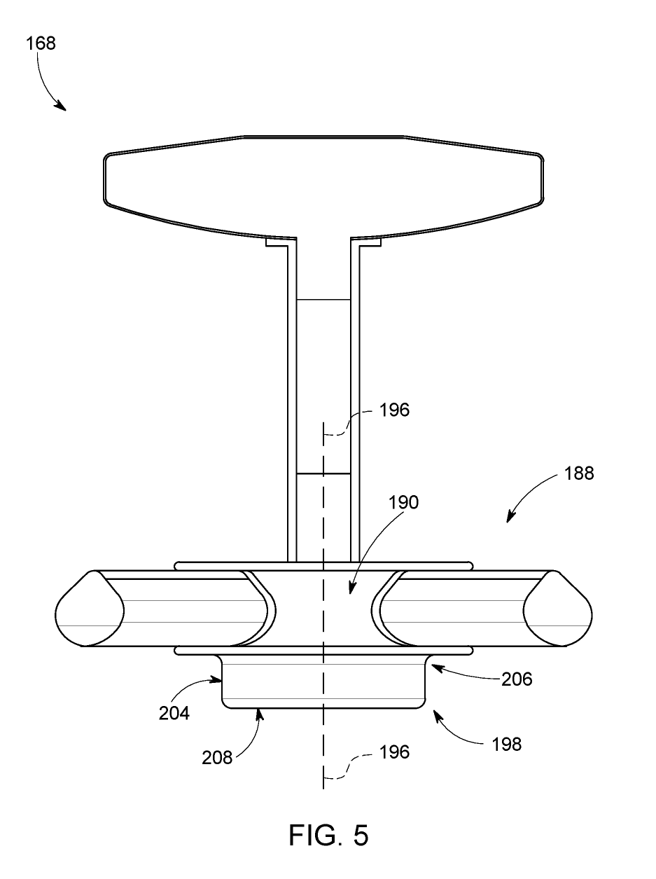

The inlet valve assembly 126 includes a valve stop 168 (not shown in FIG. 3), which as described below limits the travel of the valve body 142 in the open position of the valve body 142. The valve stop 168 will be described in more detail below with reference to FIGS. 4-11.

According to certain embodiments, at least a portion of the valve seat 140 and/or valve body 142 is formed from stainless steel. But, the valve seat 140 and/or the valve body 142 may be formed from any other material in addition or alternative to stainless steel.

In the exemplary embodiment illustrated herein, the outlet valve assembly 128 is substantially similar to the inlet valve assembly 126 and therefore will not be described in further detail.

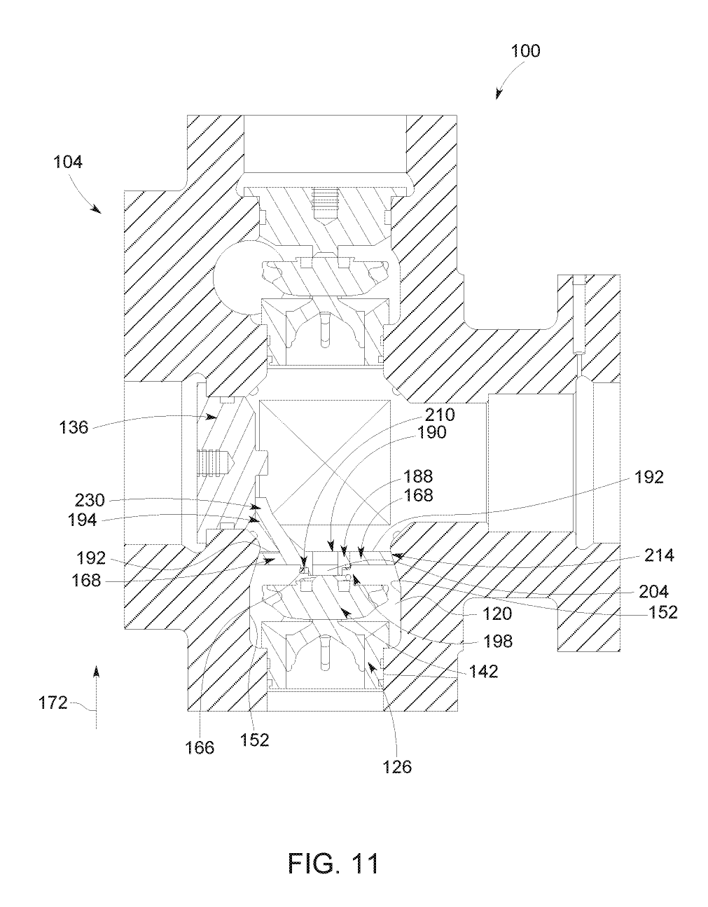

With reference now solely to FIG. 2, operation of the reciprocating pump assembly 100 is discussed. In operation, the plunger 114 reciprocates within the plunger passage 116 for movement into and out of the pressure chamber 118. That is, the plunger 114 moves back and forth horizontally, as viewed in FIG. 2, away from and towards the fluid passage axis 124 in response to rotation of the crankshaft (not shown) that is enclosed within the housing 106 (FIG. 1) of the power end portion 102 (FIG. 1). Movement of the plunger 114 in the direction of arrow 170 away from the fluid passage axis 124 and out of the pressure chamber 118 will be referred to herein as the suction stroke of the plunger 114. As the plunger 114 moves along the suction stroke, the inlet valve assembly 126 is opened to the open position of the valve body 142. More particularly, as the plunger 114 moves away from the fluid passage axis 124 in the direction of arrow 170, the pressure inside the pressure chamber 118 decreases, creating a differential pressure across the inlet valve assembly 126 and causing the valve body 142 to move upward in the direction of arrow 172, as viewed in FIG. 2, relative to the valve seat 140. As a result of the upward movement of the valve body 142, the spring 166 is compressed and the seal 164 separates from the tapered shoulder 158 of the valve seat 140 to move the valve body 142 to the open position shown in FIG. 11. In the open position of the valve body 142, fluid entering through an inlet 174 of the inlet fluid passage 120 flows along the fluid passage axis 124 and through the inlet valve assembly 126, being drawn into the pressure chamber 118. To flow through the inlet valve assembly 126, the fluid flows through the inlet valve bore 148 and along the valve seat axis 150.

As can be seen in FIG. 2, The valve stop 168 is engaged with the spring 166 to limit the travel of the valve body 142 in the open position. More particularly, the valve stop 168 prevents the valve body 142 from moving past the fully open position of the valve body 142 that is shown in FIG. 11. Operation of the valve stop 168 will be described in more detail below with reference to FIG. 11.

During the fluid flow through the inlet valve assembly 126 and into the pressure chamber 118, the outlet valve assembly 128 is in a closed position wherein a seal 176 of a valve body 178 of the outlet valve assembly 128 is engaged with a shoulder 180 of a valve seat 182 of the outlet valve assembly 128. Fluid continues to be drawn into the pressure chamber 118 until the plunger 114 is at the end of the suction stroke of the plunger 114, wherein the plunger 114 is at the farthest point from the fluid passage axis 124 of the range of motion of the plunger 114.

At the end of the suction stroke of the plunger 114, the differential pressure across the inlet valve assembly 126 is such that the spring 166 of the inlet valve assembly 126 begins to decompress and extend, forcing the valve body 142 of the inlet valve assembly 126 to move downward in the direction of arrow 184, as viewed in FIG. 2. As a result, the inlet valve assembly 126 moves to the closed position of the valve body 142 shown in FIG. 2 wherein the seal 166 of the valve body 142 is sealingly engaged with the shoulder 158 of the valve seat 140.

Movement of the plunger 114 in the direction of arrow 186 toward the fluid passage axis 124 and into the pressure chamber 118 will be referred to herein as the discharge stroke of the plunger 114. As the plunger 114 moves along the discharge stroke into the pressure chamber 118, the pressure within the pressure chamber 118 increases. The pressure within the pressure chamber 118 increases until the differential pressure across the outlet valve assembly 128 exceeds a predetermined set point, at which point the outlet valve assembly 128 opens and permits fluid to flow out of the pressure chamber 118 along the fluid passage axis 124, being discharged through the outlet valve assembly 128. As the plunger 114 reaches the end of the discharge stroke, the valve body 142 of the inlet valve assembly 126 is positioned in the closed position wherein the seal 164 is sealingly engaged with the shoulder 158 of the valve seat 140.

Although shown herein as being a helical (i.e., coil) compression spring, additionally or alternatively the spring 166 can include any type of spring, such as, but not limited to, a flat spring, a machined spring, a serpentine spring, a torsion spring, a tension spring, a constant spring, a variable spring, a variable stiffness spring, a leaf spring, a cantilever spring, a volute spring, a v-spring, and/or the like.

Referring now to FIG. 4, the valve stop 168 of the inlet valve assembly 126 (FIGS. 2, 3, and 11) includes a body 188 having a hub 190, legs 192 that extend radially outward from the hub 190, and a locator 194. The hub 190 extends a thickness along a central longitudinal axis 196 from a stop side 198 to an opposite side 200. In the exemplary embodiment, the hub 190 has a circular shape having a diameter D. But, additionally or alternatively the hub 190 can include any other shape, such as, but not limited to, a rectangular shape, another quadrilateral shape, a triangular shape, an oval shape, a hexagonal shape, an octagonal shape, and/or the like. The size and/or shape of the hub 190 may be selected to facilitate (e.g., decrease turbulence, increase flow rate, etc.) the flow of fluid over and/or around the hub 190. For example, a cross-sectional shape (e.g., taken along a plane that extends approximately parallel to the central longitudinal axis 196) of the hub 190 may be selected to provide the hub 190 with a profile that facilitates the flow of fluid over and/or around the hub 190. In some examples, the cross-sectional shape of the hub 190 provides the hub 190 with a curved and/or tapered profile, such as, but not limited to, a teardrop profile, a circular profile, an oval profile, a triangular profile, a trapezoidal profile, a diamond profile, a hexagonal profile, an octagonal profile, and/or the like. The body 188 of the valve stop 168 may be referred to herein as a “stop body”.

The hub 190 includes an optional opening 202 extending through the thickness of the hub 190. As will be described in more detail below, the opening 202 enables fluid to flow through the hub 190 when the valve body 142 (FIGS. 2, 3, and 11) is in the open position. In the exemplary embodiment, the opening 202 provides the hub 190 with a ring shape extending around the central longitudinal axis 196 such that the exemplary hub 190 is an annulus, as can be seen in FIG. 4. Although shown as having a circular shape, the opening 202 can include any other shape in addition or alternatively to the circular shape shown herein, such as, but not limited to, a rectangular shape, another quadrilateral shape, a triangular shape, an oval shape, a hexagonal shape, an octagonal shape, and/or the like. The size and/or shape of the opening 202 may be selected to facilitate (e.g., decrease turbulence, increase flow rate, etc.) the flow of fluid through the opening 202.

Referring now to FIGS. 4-7, the stop side 198 of the hub 190 includes a spring perch 204 that extends outward along the central longitudinal axis 196. The spring perch 204 extends a length along the central longitudinal axis 196 from a base 206 (not visible in FIG. 4) of the spring perch 204 to an end portion 208 of the spring perch 204. As will be described in more detail below, the spring perch 204 is configured to be received within an end 210 (FIG. 11) of the spring 166 (FIGS. 2, 3, and 11) of the inlet valve assembly 126 (FIGS. 2, 3, and 11) to facilitate maintaining the engagement between the spring 166 and the valve stop 168 during operation of the inlet valve assembly 126.

In the exemplary embodiment, the spring perch 204 has a cylindrical shape that is defined by a circular cross-sectional shape having an approximately uniform diameter along a majority of the length of the spring perch 204. But, additionally or alternatively, the spring perch 204 can include any other shape, such as, but not limited to, a rectangular cross-sectional shape, another quadrilateral cross-sectional shape, a triangular cross-sectional shape, an oval cross-sectional shape, a hexagonal cross-sectional shape, an octagonal cross-sectional shape, a shape that is tapered inwardly and/or outwardly relative to the central longitudinal axis 196 along the length of the spring perch 204 (e.g., a conical shape, a frusto-conical shape, a square pyramid, a tetrahedron, another type of pyramid, a pyramidal frustum shape, a cylindrical shape having a non-uniform diameter along the length thereof), and/or the like. The size and/or shape of the spring perch 204 may be selected to facilitate holding the spring perch 204 within the end 210 of the spring 166. In some examples, the size and/or shape of the spring perch 204 is selected such that the spring perch 204 is received within the end 210 of the spring 166 with an interference-fit or a snap-fit connection.

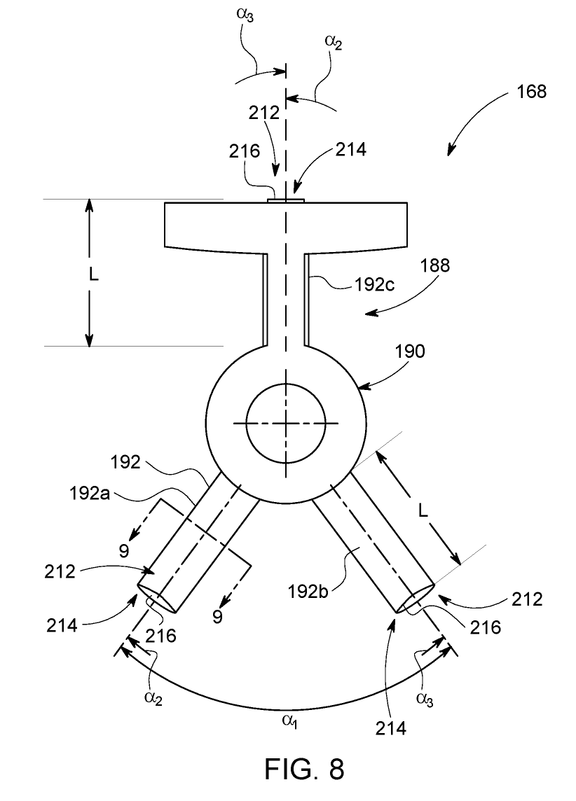

Referring now to FIGS. 4 and 8, the legs 192 extend radially outward from the hub 190 as is described above and can be seen in FIGS. 4 and 8. Each leg 192 extends a length L outward from the hub 190 to an end portion 212 of the leg 192. As will be described below, the end portion 212 of each leg 192 includes a tip 214 that is configured to engage the wall 152 (FIGS. 2, 3, and 11) of the inlet fluid passage 120 (FIGS. 2, 3, and 11) to facilitate holding the valve stop 168 within the inlet fluid passage 120 as well as stabilizing the valve stop 168 during operation of the inlet valve assembly 126. More particularly, the tip 214 of each leg 192 includes a tip surface 216 that engage the wall 152 of the inlet fluid passage 126. In some examples, the tip surface 216 of one or more of the legs 192 engages the wall 152 via a stiction element (not shown, e.g., rubber, plastic, a polymer, etc.) disposed between the tip surface 216 and the wall 152 to facilitate maintaining stiction between the tip surface 216 and the wall 152. Optionally, the tip surface 216 of one or more of the legs 192 has a curvature that complements the curvature of the circumference of the wall 152 of the inlet fluid passage 120. For example, the tip surface 216 of one or more of the legs 192 may be curved within a plane that extends approximately perpendicular to the central longitudinal axis 196. The length L of each leg 192 is selected based on the diameter of the inlet fluid passage 120 at the position of the valve stop 168 therein.

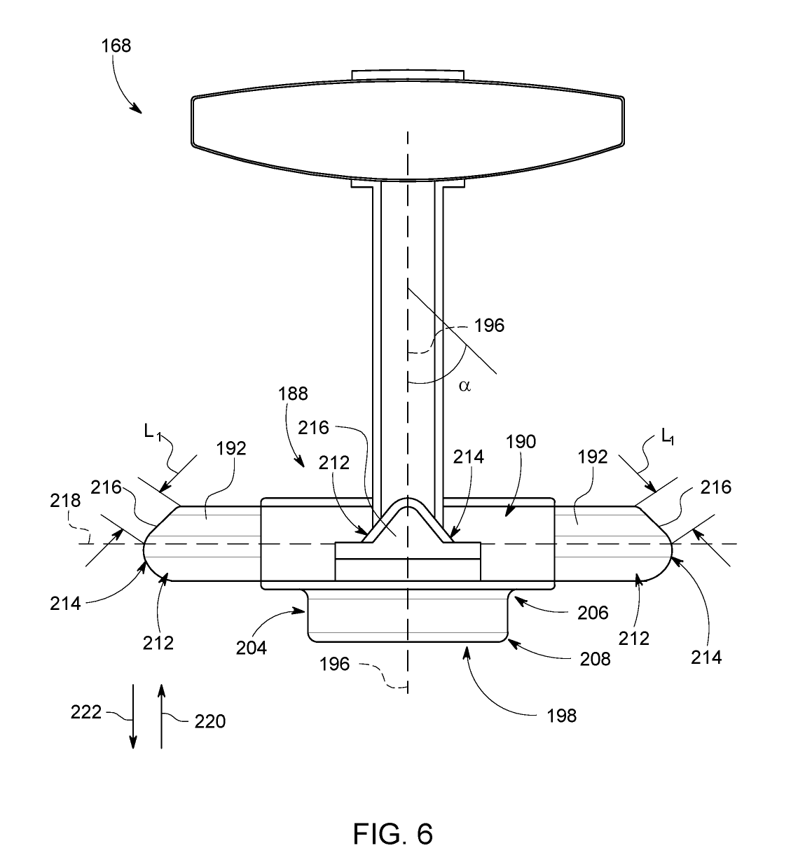

In some examples, the valve stop 168 is held within the inlet fluid passage 120 at a position along the length of the inlet fluid passage 120 (i.e., along the fluid passage axis 124 shown in FIGS. 2, 3, and 11) where the wall 152 of the inlet fluid passage 120 is tapered relative to the fluid passage axis 124. In some embodiments, the tip surface 216 of the legs 192 extends at a non-parallel angle relative to the central longitudinal axis 196 of the hub 190 such that the tip surface 216 has a complementary taper relative to the wall 152. For example, and referring now to FIG. 6, the tip surface 216 of the end portions 212 of each leg 192 is shown as extending a length L₁ that extends at an oblique angle α relative to the central longitudinal axis 196. The angle α is selected to be complementary with a taper of the wall 152 of the inlet fluid passage 120. In other embodiments, the length L₁ of the tip surface 216 of one or more of the legs 192 extends at a non-parallel angle relative to the central longitudinal axis 196 that is not complementary with a taper of the wall 152 at the location of the valve stop 168 along the length of the wall 152. Moreover, the tip surfaces 216 may be curved along the length L₁ thereof in some embodiments, for example to be complementary with a curvature of the wall 152.

Referring again to FIG. 8, the exemplary embodiment of the body 188 of the valve stop 168 includes a tripod that has three legs 192 that extend radially outward from the hub 190. But, the body 188 can include any number of the legs 192, such as, but not limited to, two legs 192, four legs 192, five legs 194, six legs 196, etc. As shown in FIG. 8, the legs 192 are shown as having a radial pattern wherein two of the legs 192a and 192b are spaced radially apart by an angle α₁ of approximately 72° and a third leg 192c is spaced radially apart from the legs 192a and 192b by angles α₂ and α₃ of approximately 144°. But, the legs 192 of the valve stop 168 may be arranged in any radial pattern (e.g., each of the angles α₁, α₂, and α₃ may have any value, etc.).

Referring again to FIG. 6, the lengths L of the legs 192 extend approximately perpendicular relative to central longitudinal axis 196 of the hub 190 in the exemplary embodiment of the legs 192. But, in other examples, the length L of one or more of the legs 192 extends at an oblique angle relative to the central longitudinal axis 196 such that the leg 192 is inclined or declined at an angle relative to the hub 190 (i.e., relative to a central latitudinal axis 218 of the hub 190). For example, the length L of one or more of the legs 192 may extend at an oblique angle relative to the central longitudinal axis 196 such that the leg(s) 192 is inclined in the direction of the arrow 220 relative to the hub 190. In addition or alternatively to one or more legs being inclined relative to the hub 190, the length L of one or more of the legs 192 may extend at an oblique angle relative to the central longitudinal axis 196 such that the leg(s) 192 is declined in the direction of the arrow 222 relative to the hub 190. Each leg 192 may be inclined or declined at any angle relative to the central latitudinal axis 218 of the hub 190, such as, but not limited to, an angle of between approximately 2° and approximately 25°, an angle of between approximately 20° and approximately 75°, and/or the like.

The number of legs 192, the radial pattern of the legs 192, an inclination of each of the legs 192, and/or a declination of each of the legs 192 may be selected to facilitate (e.g., decrease turbulence, increase flow rate, etc.) the flow of fluid through the body 188 of the valve stop 168 (e.g., between the legs 192, around the legs 192, etc.). Moreover, the number of legs 192 may be selected to facilitate stabilizing the body 188 of the valve stop 168 during operation of the inlet valve assembly 126 (FIGS. 2, 3, and 11).

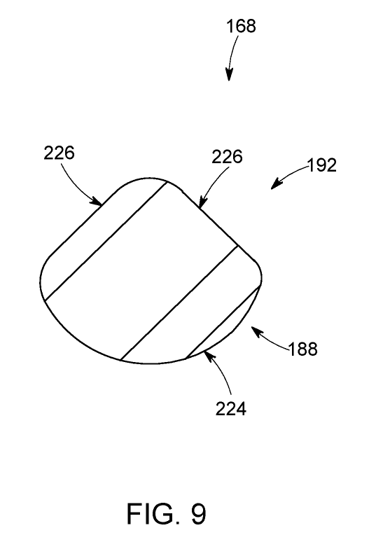

Referring again to FIG. 8, one or more of the legs 192 may be provided with a shape that facilitates (e.g., decreases turbulence, increases flow rate, etc.) the flow of fluid through the body 188 of the valve stop 168 (e.g., around the legs 192, between the legs 192, etc.). For example, the exemplary embodiment of the legs 192 have cross-sectional shapes the provide the legs 192 with a teardrop profile, as shown in the cross-section of FIG. 9 taken along the line 9-9 of FIG. 8. More particularly, and referring now solely to FIG. 9, the legs 192 include a curved segment 224 and a tapered segment 226 that extends from the curved segment 224. The curved segment 224 is configured to face opposite the direction of the flow of fluid through the valve stop 168 such that the curved segment 224 provides a leading edge of the leg 192 and the tapered segment 226 provides a trailing edge of the leg 192 relative to the direction of fluid flow. The curved segment 224 and the tapered segment 226 thus provide a teardrop profile of the leg 192 around which fluid flows similar to a drop of water falling through the air. The teardrop profile of the legs 192 may decrease turbulence, increase the flow rate, and/or the like of fluid flowing through the valve stop 168.

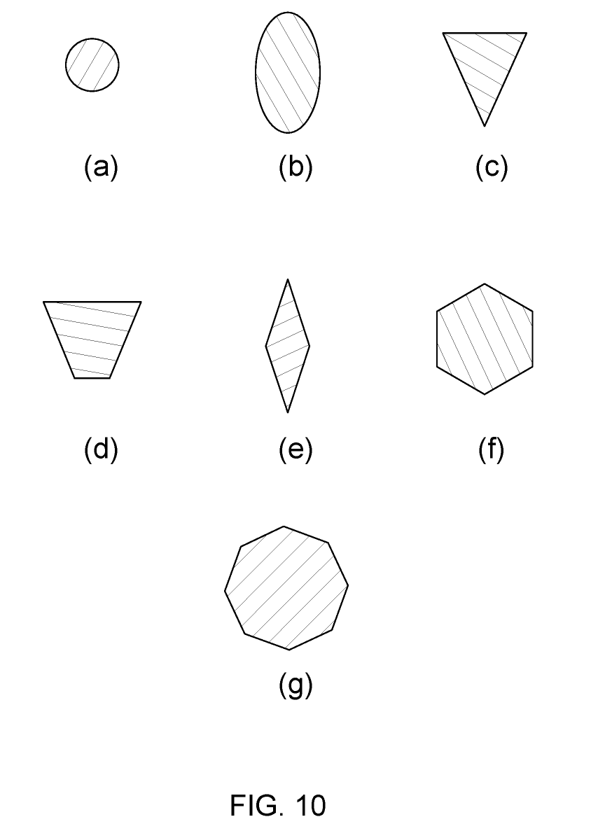

The legs 192 are not limited to the teardrop profile illustrated herein, but rather other curved and/or tapered profiles may be provided in addition or alternative to the teardrop profile to facilitate the flow of fluid through the body 188 of the valve stop 168 (e.g., one or more legs 192 may be provided with a teardrop profile while one or more other legs are provided with a different profile, one or more legs 192 may be provided with a partial teardrop profile, etc.). Examples of other profile shapes that may be provided to facilitate the flow of fluid are illustrated in FIG. 10 and include, but are not limited to, the circular profile shown in FIG. 10(a), the oval profile shown in FIG. 10(b), the triangular profile shown in FIG. 10(c), the trapezoidal profile shown in FIG. 10(d), the diamond profile shown in FIG. 10(e), the hexagonal profile shown in FIG. 10(f), and the octagonal profile shown in FIG. 10(g). Other profiles of the legs 192 may be provided in addition or alternative to the profiles shown and/or described herein to facilitate the flow of fluid through the body 188 of the valve stop 168. Moreover, the cross-sectional size of the legs 192 may be selected to facilitate (e.g., decrease turbulence, increases flow rate, etc.) the flow of fluid through the body 188 of the valve stop 168 (e.g., around the legs 192, between the legs 192, etc.).

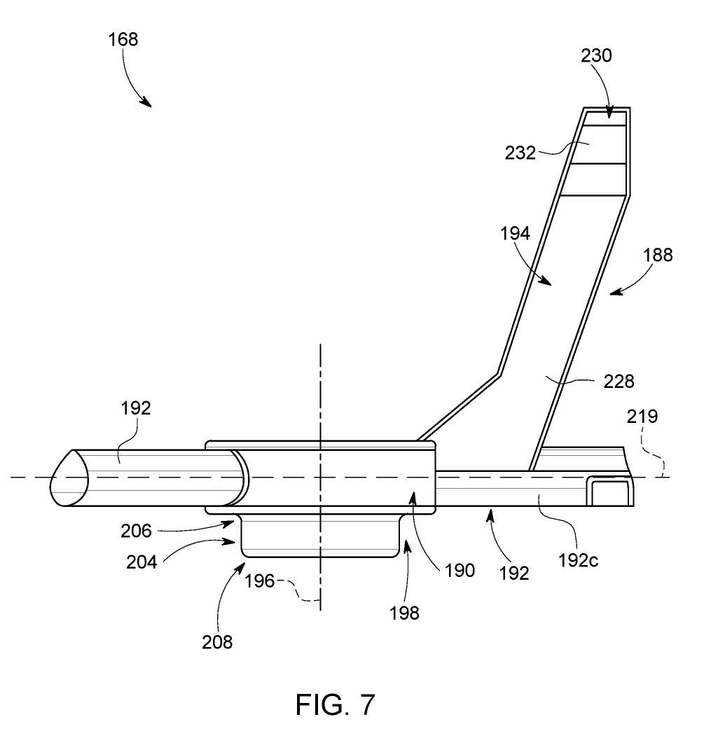

Referring now to FIGS. 4 and 7, as described above the body 188 of the valve stop 168 includes the locator 194. The locator 194 includes a stem 228 that extends outward from the hub 190 and the leg 192c in the exemplary embodiment. In other examples, the locator 194 extends outward from only the hub 190 or extends outward from only the leg 192c. The stem 228 extends outward from the hub 190 and the leg 192c to a crossbar 230 of the locator 194. As will be described below in more detail below with reference to FIG. 11, the crossbar 230 of the locator 194 is configured to engage an internal portion of the pump assembly 100 (e.g., the suction cover 136 shown in FIGS. 2 and 11, etc.) shown in FIGS. 1, 2, and 11) to facilitate locating and/or stabilizing the valve stop 168 within the inlet fluid passage 120 (FIGS. 2, 3, and 11). As will also be described below, the crossbar 230 of the locator 194 defines a handle that can be grasped by an installer to facilitate installing the valve stop 168 within the inlet fluid passage 120. Although shown as having two arms 232 that extend outward in opposite directions from the stem 228, the crossbar 230 can include any number of the arms 232. In other examples, the crossbar 230 has only one arm 232, has three arms 232, etc.

In the exemplary embodiment, the stem 228 of the locator 194 extends at an oblique angle relative to the central longitudinal axis 196 and the central latitudinal axis 218 of the hub 190 such that the stem extends outward from the hub 190 generally away from the central longitudinal axis 196. But, in other examples the stem 228 extends outward from the hub 190 at an oblique angle generally toward the central longitudinal axis 196 or at an approximately parallel angle relative to the central longitudinal axis 196. The angle of the stem 228, the size of the stem 228, and/or the size of the crossbar 230 may be selected to facilitate locating the valve stop 168 within the inlet fluid passage 120.

The size and/or shape of the locator 194 may be selected to facilitate (e.g., decrease turbulence, increase flow rate, etc.) the flow of fluid over and/or around the locator 194. For example, the stem 228 and/or the crossbar 230 of the locator 194 may be provided with a profile that facilitates the flow of fluid over and/or around the locator 194, such as, but not limited to a curved and/or tapered profile, and/or the (e.g., a teardrop profile, a circular profile, an oval profile, a triangular profile, a trapezoidal profile, a diamond profile, a hexagonal profile, an octagonal profile, etc.).

FIG. 11 is a cross-sectional view of the fluid end portion 104 of the reciprocating pump assembly 100 illustrating the valve stop 168 installed within the inlet fluid passage 120. More particularly, the body 188 of the valve stop 168 has been positioned into the inlet fluid passage 120 such that the stop side 198 of the hub 190 faces the valve body 142. As can be seen in FIG. 11, the spring perch 204 of the valve stop 168 is received within the end 210 of the spring 166 of the inlet valve assembly 126 such that the stop side 198 of the hub 190 is engaged with the spring 166. The tips 214 of the legs 192 of the valve stop 168 are engaged with the wall 152 of the inlet fluid passage 120 and the crossbar 130 of the locator 194 is engaged with the suction cover 136 of the fluid end portion 104. The engagement between the crossbar 230 of the locator 194 and the suction cover 136 facilitates locating the body 188 of the valve stop 168 within the internal fluid passage 120 in the proper position that enables the valve stop 168 to limit travel of the valve body 142 as described below. The locator 194 thus may enable the valve stop 168 to be more precisely installed within the inlet fluid passage 120 by an installer, for example as compared to at least some known valve stops. In addition or alternatively to the suction cover 136, in other examples the crossbar 230 of the locator 194 engages another internal portion of the fluid end 104 that enables the locator 194 to function as described and/or illustrated herein.

As described above, the crossbar 230 of the locator 194 defines a handle of the locator 194, which may enable easier and/or safer installation of the valve stop 168. For example, the crossbar 230 of the locator 194 can be grasped by an installer and thereby provide a handle that may enable the installer to insert the body 188 of the valve stop 168 into position within the inlet fluid passage 120 without using any tools. Moreover, and for example, the handle provided by the crossbar 230 may provide a secure and relatively smooth and/or flat structure that enables the installer to wedge the body 188 of the valve stop 168 into position within the inlet fluid passage 120 without injury (e.g., being cut, scrapped, etc.). For example, the relatively smooth and/or flat structure of the crossbar 230 may prevent the installer's hand from being injured directly from contact with the body 188. Moreover, and for example, the secure handle provided by the crossbar 230 may prevent the installer's hand from slipping off the body 188 and being injured by impact with the interior of the fluid end 104 (e.g., with the wall 152, the suction cover 136, an edge, etc.).

Operation of the valve stop 168 will now be described. As the valve body 142 moves in the direction of the arrow 172 to the open position shown in FIG. 11, the spring 166 reaches full compression and the engagement between the spring 166 and the body 188 of the valve stop 168 thereby limits the valve body 142 from traveling further in the direction of the arrow 172. In the exemplary embodiment, the engagement between the spring 166 and the valve stop 168 thus not only provides a rigid structure that enables the spring 166 to compress and decompress and thereby control the opening and closing movements of the valve body 142, but also prevents the valve body 142 from moving past the fully open position of the valve body 142 that is shown in FIG. 11. In the fully open position of the valve body 142, the exemplary embodiment of the valve stop 168 also engages the valve body 142 at the spring perch 204 to limit the travel of the valve body 142 in the direction of the arrow 172, as is shown in FIG. 11. But, in other embodiments the body 188 of the valve stop 168 does not directly engage the valve body 142 in the fully open position of the valve body 142. Moreover, in some other embodiments, the spring 166 operates separately from the valve stop 168 and the valve stop 168 only engages the valve body 142 to limit travel of the valve body 142 in the direction of the arrow 172.

During operation of the valve stop 168 as described above, the engagement between the legs 192 and the wall 152 as well as the engagement between the locator 194 and the suction cover 136 stabilizes the valve stop 168 (e.g., prevents the body 188 of the valve stop 168 from rocking, etc.). The number, size, and/or shape of the legs 192 of the valve stop 168 may be selected to a predetermined amount of stabilization to the body 188 while also providing the body 188 with predetermined flow characteristics. For example, the exemplary embodiment of the valve stop 168 includes three legs 192 to facilitate providing an amount of stabilization to the body 188 that enables the body 188 to remain in position and function as described and/or illustrated herein during operation of the inlet valve assembly 126. Moreover, and for example, the exemplary embodiment of the valve stop 168 also provides the legs 192 (and/or the hub 190) with the curved and/or tapered profiles that may facilitate providing less of an impediment (e.g., enable greater flow rate, generate less turbulence, etc.) to the flow of fluid through the inlet fluid passage 120.

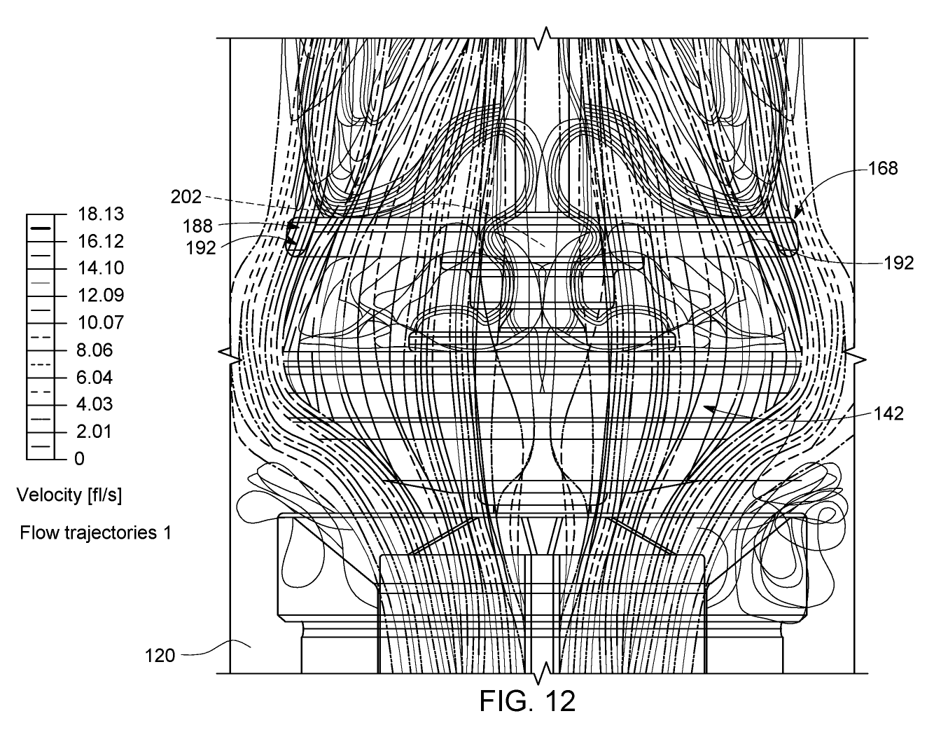

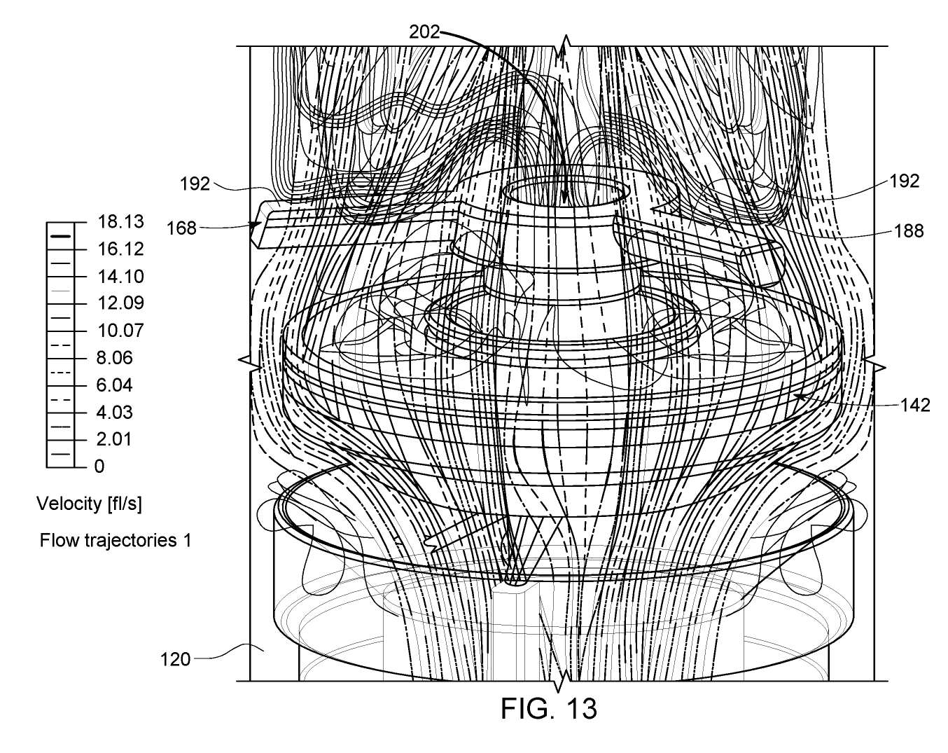

FIGS. 12 and 13 illustrate an example of the flow of fluid through the valve stop 168. In the open position of the valve body 142, fluid flows through the body 188 of the valve stop 168 between and around the legs 192 and through the opening 202 of the hub 190. As can be seen in FIGS. 10 and 11, the curved and/or tapered profiles of the legs 192 enable fluid to flow through the body 188 of the valve stop 168 with a relatively high flow rate while generating a relatively low amount of turbulence. As also shown in FIGS. 12 and 13, fluid blocked from passage through the body 188 by the legs 192 is discharged through the opening 202, which may further facilitate increasing the flow rate of fluid flowing through the inlet fluid passage 120.

Although shown and described herein with respect to the inlet valve assembly 126, the valve stop embodiments described and/or illustrated herein (e.g., the valve stop 168, etc.) are not limited thereto, but rather may be used with any valve assembly. For example, the valve stop embodiments described and/or illustrated herein may be used with the outlet valve assembly 128 (FIG. 2) as a valve stop that limits travel of the valve body 178 (FIG. 2).

It is to be understood that the above description is intended to be illustrative, and not restrictive. For example, the above-described embodiments (and/or aspects thereof) may be used in combination with each other. Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Further, each independent feature or component of any given assembly may constitute an additional embodiment. In addition, many modifications may be made to adapt a particular situation or material to the teachings of the disclosure without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the disclosure should, therefore, be determined with reference to the appended claims, along with the full scope of equivalents to which such claims are entitled.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “clockwise” and “counterclockwise”, “left” and right”, “front” and “rear”, “above” and “below” and the like are used as words of convenience to provide reference points and are not to be construed as limiting terms.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. For example, in this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised”, “comprises”, “having”, “has”, “includes”, and “including” where they appear. The term “exemplary” is intended to mean “an example of” The phrase “one or more of the following: A, B, and C” means “at least one of A and/or at least one of B and/or at least one of C.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Although the terms “step” and/or “block” may be used herein to connote different elements of methods employed, the terms should not be interpreted as implying any particular order among or between various steps herein disclosed unless and except when the order of individual steps is explicitly described. The order of execution or performance of the operations in examples of the disclosure illustrated and described herein is not essential, unless otherwise specified. The operations may be performed in any order, unless otherwise specified, and examples of the disclosure may include additional or fewer operations than those disclosed herein. It is therefore contemplated that executing or performing a particular operation before, contemporaneously with, or after another operation is within the scope of aspects of the disclosure.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A valve stop for a valve assembly of a pump, said valve stop comprising:
a tripod comprising a hub and three legs extending radially outward from the hub to end portions of the legs, the tripod being configured to be operatively connected to a valve body of the valve assembly to limit travel of the valve body, the end portions of the legs being configured to engage a wall of a fluid passage of the pump; and
a locator extending outward from the tripod to a handle of the locator, the handle of the locator being configured to engage an internal portion of the pump.

2. The valve stop of claim 1, wherein the hub of the tripod comprises an opening extending therethrough.

3. The valve stop of claim 1, wherein the hub of the tripod comprises an annulus.

4. The valve stop of claim 1, wherein the hub of the tripod comprises at least one of a curved or tapered profile.

5. The valve stop of claim 1, wherein the legs of the tripod comprise at least one of a curved or tapered profile.

6. The valve stop of claim 1, wherein the locator comprises a stem that extends outward from the tripod to a crossbar of the handle.

7. The valve stop of claim 1, wherein the tripod is configured to engage a spring of the valve assembly to limit the travel of the valve body of the valve assembly.

8. The valve stop of claim 1, wherein the handle of the locator is configured to engage a suction cover of the pump.

9. A valve stop for a valve assembly of a pump, said valve stop comprising:
a stop body configured to be operatively connected to a valve body of the valve assembly to limit travel of the valve body, the stop body comprising a hub and legs extending radially outward from the hub to end portions of the legs, the end portions of the legs being configured to engage a wall of a fluid passage of the pump, wherein the legs comprise at least one of a curved or tapered profile.

10. The valve stop of claim 9, wherein the legs comprise a teardrop profile.

11. The valve stop of claim 9, wherein the legs comprise at least one of a circular, oval, triangular, trapezoidal, diamond, hexagonal, or octagonal profile.

12. The valve stop of claim 9, wherein the stop body comprises a locator extending outward from at least one of the hub or the legs, the locator being configured to engage an internal portion of the pump.

13. The valve stop of claim 9, wherein the stop body comprises a locator having a stem that extends outward from at least one of the hub or the legs to a crossbar that is configured to engage an internal portion of the pump.

14. The valve stop of claim 9, wherein the hub comprises an opening extending therethrough.

15. The valve stop of claim 9, wherein the hub comprises at least one of a curved or tapered profile.

16. A pump comprising
a fluid passage; and
a valve assembly held within the fluid passage, the valve assembly comprising a valve body configured to move between an open position and a closed position, the valve assembly comprising a valve stop comprising a tripod having a hub and three legs extending radially outward from the hub to end portions of the legs, the tripod being operatively connected to the valve body such that the tripod is configured to limit travel of the valve body in the open position of the valve body, the end portions of the legs being configured to engage a wall of the fluid passage.

17. The pump of claim 16, wherein the valve stop comprises a locator extending outward from the tripod to a handle of the locator.

18. The pump of claim 16, wherein the legs of the tripod comprise at least one of a curved or tapered profile.

19. The pump of claim 16, wherein the pump comprises a suction cover and the valve stop comprises a locator having a stem that extends outward from tripod to a crossbar of the locator, the crossbar being engaged with the suction cover.

20. The pump of claim 16, wherein the valve assembly comprising a spring configured to bias the valve body to the closed position, the tripod being engaged with the spring to limit the travel of the valve body in the open position.
